(19) United States
(12) Patent Application Publication
(10) Pub. No.: US 2007/0266065 A1
(43) Pub. Date: Nov. 15, 2007

(54) System, Method and Computer Program Product for Intelligent Groupwise Media Selection

(75) Inventor: Louis B. Rosenberg, Arroyo Grande, CA (US)

Correspondence Address: LAW OFFICE OF PHILIP A STEINER, 1212 MARSH STREET, SUITE 3, SAN LUIS OBISPO, CA, 93401, US

(73) Assignee: OUTLAND RESEARCH, LLC, Pismo Beach, CA (US)

(21) Appl. No.: 11/697,732

(22) Filed: Apr. 8, 2007

Related U.S. Application Data
(63) Continuation-in-part of application No. 11/676,298, filed on Feb. 18, 2007.
Application No. 11/676,298 is a continuation-in-part of application No. 11/425,990, filed on Jun. 22, 2006.
Application No. 11/425,990 is a continuation-in-part of application No. 11/383,197, filed on May 12, 2006.
(60) Provisional application No. 60/809,951, filed on May 31, 2006.
(60) Provisional application No. 60/897,555, filed on Jan. 26, 2007.
(60) Provisional application No. 60/843,444, filed on Sep. 8, 2006.
(60) Provisional application No. 60/898,375, filed on Jan. 30, 2007.

(51) Int. Cl. G06F 17/30

(52) U.S. Cl. 707/205; 707/E17.005

(57) ABSTRACT

A system, method, and computer program product is provided which enables customers of an establishment to collaboratively select a series of media files to be played within that establishment by entering data into a personal wireless portable computing device on their person, for example a cellular telephone. Upon entering a media file selection into a portable computing device and where necessary an establishment identifier, a message is sent over a wireless link to a media server which maintains a media menu and a playlist queue for the establishment. The establishment media server then coordinates the local play of media listed on the playlist queue through interactions with a media player local to the establishment. In this way, a plurality of separate customers may selectively use their portable computing devices to add specific musical media file selections to a playlist queue for the designated establishment. The playlist queue is then used to coordinate the sequential play of musical media files through speakers within the establishment such that the customers of the establishment can listen to the collaboratively selected media files. Customers may then be charged a fee for making musical selections for public play within a designated physical establishment.

### CROSS-REFERENCE TO RELATED APPLICATIONS

This application claims benefit and priority; under 35 U.S.C. § 119(e) U.S. from provisional patent application Ser. Nos. 60/809,951 filed May 31, 2006 and 60/897,555 filed Jan. 26, 2007. This application is also a continuation-in-part of co-pending non-provisional U.S. patent application Ser. No. 11/676,298 filed Feb. 18, 2007. This application is also a related application to co-pending U.S. non-provisional patent application Ser. Nos. 11/223,386 filed on Sep. 9, 2005; Ser. No. 11/267,079 filed on Nov. 3, 2005; and Ser. No. 11/285,534 filed on Nov. 22, 2005. All of the patent applications identified above are to the instant inventor and a common assignee and are hereby incorporated by reference in their entirety as if fully set forth herein.

In addition, this application claims benefit and priorities under 35 U.S.C. § 119(e) from provisional patent application Ssr. Nos. 60/843,444 filed Sep. 8, 2006 and 60/898,375 filed Jan. 30, 2007.

This application is also a continuation in part of co-pending non-provisional patent application Ser. Nos. 11/425,990 filed on Jun. 22, 2006 and 11/383,197 filed on May 12, 2006. The aforementioned applications claimed benefit and priorities from provisional application Ser. Nos. 60,731,180 filed Oct. 29, 2005; and 60,723,021 filed Oct. 1, 2005 respectively.

All of the aforementioned patent applications are to the instant inventor and a common assignee.

### RELEVANT INVENTIVE FIELD

The various exemplary embodiments relate generally to media file selection systems that enable a plurality of customers to collaboratively select a sequence of media files for play within a local establishment and more specifically to a distributed mechanisms by which a plurality of customers in possession of portable computing devices may wirelessly add media files to a playlist queue of media files to be played within a particular physical establishment such as a restaurant, bar, club, or gym.

### BACKGROUND

In recent years, wireless phones and other similar portable wireless computing devices have become nearly universally carried by people around much of the world. Presently, wireless portable communication devices enable more than just person to person voice communication, enabling wireless data transmission as well. Wireless data transmission is enabled in a variety of ways including text messaging over phone networks, Bluetooth communication connections over ad hock networks, Wi-Fi communication, and other wireless communication connections. Using such available technologies, customers may selectively interact with remote servers over wireless communication links by entering data into a portable wireless computing device on their person. Even though many people in the industrialized world today, who visit physical establishments such as restaurants, bars, gyms, and clubs, enter those establishments equipped with at least one wireless portable computing device upon their person, there currently is no mechanism by which customers of a localized physical establishment may easily influence their environment by using their wireless portable computing device.

### SUMMARY

The above described needs in the relevant art are addressed by the various exemplary embodiments disclosed herein. Exemplary systematic, methodic, and computer readable storage media descriptions are provided which enables customers present in an establishment to collaboratively select media files to be played within that establishment by entering data into a wireless portable computing device on their person, for example a cellular telephone. Upon entering a media file selection into the portable computing device and where necessary an establishment identifier, a message is sent over a wireless link to a media server which maintains a media menu for the establishment.

The media server then coordinates the local play of media included in a playlist queue through interactions with a media player local to the establishment. In this way, a plurality of separate customers may selectively use their portable computing devices to add specific musical media file selections to the playlist queue for the designated establishment. The playlist queue is then used to coordinate the sequential play of musical media files through speakers within the establishment such that the customers of the establishment can listen to the collaboratively selected media files. Customers may then be charged a fee for making musical selections for public play within a designated physical establishment.

In various exemplary embodiments, the network may include a cellular network, a cellular network coupled by a gateway to a public packet switched network and a local wireless network coupled by a gateway to a public packet switched network.

In an exemplary embodiment, a distributed media selection system is provided which comprises a media server coupled to a network. The media server includes a processor and a computer readable storage medium coupled to the processor.

The computer readable storage medium includes a first database component having retrievably stored therein; a plurality of physical establishment records, each physical establishment record is associated with a physical establishment and a media playlist queue associated with each physical establishment record, each media playlist queue includes a listing of unique media file identifiers, each of which being associated with a media file.

A set of logical instructions are provided which when executed by the processor cause the processor to receive a plurality of media requests over the network, update each media playlist queue corresponding to each unique establishment identifier with each unique media identifier included in each media request, and cause each media file corresponding to each unique media identifier to be publicly output at each physical establishment corresponding to each unique establishment identifier included in each media request. In an exemplary embodiment, a second database component is coupled to the processor having retrievably stored therein a media menu corresponding to each unique establishment identifier, each media menu comprising a listing of media files and their corresponding unique media identifiers available for selection from each corresponding physical establishment.

In an exemplary embodiment, the plurality of media requests may be sent from a plurality of cellular telephones in wireless communications with the media server over the network. The plurality of media requests comprises an SMS formatted text message.

In an exemplary embodiment, each of the plurality of media requests further includes a unique customer identifier.

In an exemplary embodiment, a third database component is coupled to the processor having retrievably stored therein a plurality of customer account records, each of the customer account records having a unique customer identifier associated therewith.

In a related exemplary embodiment, logical instructions are provided which when executed by the processor cause the processor to retrieve each customer account record from the third database component corresponding to the unique customer identifier included in each received request and charge a fee to each retrieved customer account record in dependence on whether a requested media file was publicly output at the physical establishment. The unique customer identifier includes a phone number of a portable computing device from which the corresponding media request originated.

In another related exemplary embodiment, the unique customer identifier includes a text messaging address, a customer handle, or a customer name.

In various exemplary embodiments, the output at each physical establishment is accomplished by media players coupled to the network; the media players receive the media files for output from the media server over the network; the media players receive streaming media for output from the media server over the network; the media players receive the unique media identifiers corresponding to their corresponding media playlist queue from the media server and retrieves the requested media files from local datastores coupled to the media players.

In an exemplary embodiment, a physical menu may be disposed within each of the plurality of physical establishments. The physical menu includes a listing of a plurality of media files and associated unique media identifiers available for selection and play within each physical establishment. The physical menu further includes the unique establishment identifier associated with the physical establishment in which the physical menu is disposed. The media menu may be downloadable from the media server to a personal portable computing device in dependence on the unique establishment identifier included in the media request. In a related exemplary embodiment, additional logical instructions are provided which when executed by the processor cause the processor to retrieve each customer account record from the third database component in dependence on the unique customer identifier included in each received request and store a usage record in the customer account record, the usage record including an indication of a requested media file and an identified physical establishment included in the received request.

### BRIEF DESCRIPTION OF DRAWINGS

The features and advantages of the various exemplary embodiments will become apparent from the following detailed description when considered in conjunction with the accompanying drawings. Where possible, the same reference numerals and characters are used to denote like features, elements, components or portions of the inventive embodiments. It is intended that changes and modifications can be made to the described exemplary embodiments without departing from the true scope and spirit of the inventive embodiments as is defined by the claims.

FIG. 1—depicts a generalized block diagram of a general purpose computer system suitable for use in the various described exemplary embodiments.

FIG. 2—depicts an exemplary block diagram of a computer system configured as a media player is in processing communications over at least one network with a plurality of wireless portable computing devices.

FIG. 2A—depicts an exemplary block diagram in which a media player is in processing communications over at least one network with a remote media server which is in processing communication with a plurality of wireless portable computing devices over a wireless network.

FIG. 2B—depicts an exemplary block diagram in which a plurality of media players, each associated with a separate physical establishment, is in processing communications over a network with a remote media server.

FIG. 3—depicts a process flowchart for the various exemplary embodiments disclosed herein.

### DETAILED DESCRIPTION

An increasing number of consumer products are incorporating circuitry to play musical media files and other electronic media. An example of which is discussed in Apple Computer, Inc., patent application, US 2004/0224638 A1, Ser. No. 10/423,490 to Fadell, et al., which is herein incorporated by reference in its entirety. Such technologies are generally referred to as media players and enable large numbers of musical media files to be stored in an electronic memory and selectively accessed for play through an audio output. Often physical establishments employ media playing devices to play musical media to the customers of those establishments through speakers mounted in the walls and/or ceiling of the establishment.

In common exemplary embodiments, a digital playlist or other digital sequencing of musical media files may define the available musical media to be played to the customers of a physical establishment through audio speakers. In some exemplary embodiments, the musical media is stored locally within a computer readable storage medium on the premises of the establishment and are selectively accessed for play to the customers using a preplanned playlist, an automated selection process, and/or a combination of thereof.

In other exemplary embodiments, the musical media files are remotely stored on an off premises server and are received or streamed over a communication link for local play to the customers of that establishment. Whichever architecture is employed, hardware and software infrastructures may be configured to enable musical media to be played to customers of an establishment based upon preplanned sequencing of musical media files and/or based upon an automated selection, for example randomized selection, of musical media files.

In an exemplary embodiment, a plurality of customers are in proximity to a localized physical establishment, such as a restaurant, bar, coffeehouse, retail store, section of a mall, or airport terminal, each customer having a wireless portable computing device on their person. The methods, apparatus, and computer program products enable the plurality of customers to select the sequence of musical media files that are played within the establishment by entering selection data into their personal wireless computing device and sending the selection data to a media server. The media server may be a local computer and/or media player, or a remote server. In many exemplary embodiments, the media server is a remote server that services a plurality of localized physical establishments, each localized physical establishment being identified by a unique establishment identifier or other unique identifier. The media server is configured to independently coordinate the play of media files within each of one or more localized physical establishments.

In an exemplary embodiment, the wireless portable computing device is a wireless phone, for example, a cellular telephone that is configured to send and receive data to the media server over a communication network. In this way, a customer of a physical establishment such as a restaurant, bar, gym, or club, may use their own personal wireless portable computing device (i.e. their phone) to select media files that are added to a pending playlist queue of media files to be played within an identified physical establishment. In various exemplary embodiments, customers are charged a per-selection fee for selecting media files for public play within a localized physical establishment using their personal wireless portable computing device, and/or are charged a subscription fee for being enabled to select media files for public play within a localized physical establishment using their personal wireless portable computing device.

In an exemplary embodiment, the customers send a text message, for example, a short messaging service (SMS) text message to the media server, the text message indicating the particular establishment for which the customer desires to add a media file to a pending localized establishment playlist queue and indicating the particular media file(s) requested to be added to the establishment's playlist queue. In some exemplary embodiments, the particular establishment and the particular media files(s) are encoded within a single electronic message. In other embodiments the establishment and the particular media files(s) are encoded within separate electronic messages.

In many exemplary embodiments the particular establishment is identified using a unique establishment identifier or other unique identifier that is specific the particular establishment, thereby enabling the identification of a particular establishment from among a plurality of possible establishments serviced by the media server. Similarly, in many embodiments each particular media file is identified using a unique media identifier or other unique identifier that is specific the particular media file, thereby enabling the identification of a particular media file from among a plurality of possible media files supported by the media server. In some such exemplary embodiments, each unique establishment uses a different coding scheme for the media files available for play within that establishment. In other exemplary embodiments, a common coding scheme is used for media files across a plurality of separate localized physical establishments.

In some exemplary embodiments, the customer may also download an establishment specific media menu to his or her portable computing device, the media menu indicating a set of media files from which a selection may be made for play within the particular establishment. For example, a media menu for a particular establishment may comprise a listing of hundreds or thousands of songs that are available for play within a particular establishment, each encoded with a unique identifier. Once selected for play within a particular establishment, an indication of the selected media file may be added to an establishment-specific playlist queue for that establishment, as is generally stored upon or otherwise accessible to the media server.

In some exemplary embodiments, the customer may download the current pending playlist queue from the media server for a particular establishment, for viewing on his or her portable computing device as it is currently pending for play within the particular establishment. In an exemplary embodiment, a local media player is configured to output songs to customers of a localized physical establishment through speakers of the establishment, the playing media being organized by a playlist queue (or other queuing means) maintained by the media server. The media player may be incorporated into a computer local to the establishment as is commonly performed using personal computer sound cards.

In various exemplary embodiments, a system, method and computer product are provided by which allows the customers to be easily billed for adding musical media selections to the sequence of musical media selections being played to the customers of a particular localized physical establishment. In some such exemplary embodiments, the billing is provided through a reverse SMS billing process in which customers are billed for one or more media selections for public play through a text messaging fee that is added to their standard cellular phone bill. In this way, customers may be billed without requiring a billing transaction separate from their standard phone bill payment transaction. In some exemplary embodiments, customers may purchase a plurality of credits with a single billing transaction, each of the plurality of credits being redeemable for a music selection within a localized physical establishment. In some such exemplary embodiments, a plurality of customer accounts, each indicating the number of available credits for an associated customer may be stored upon or otherwise be accessible to the media server.

In this way, the customers of an establishment may select for a fee, the music that is to be publicly played to other customers within the establishment by using his or her portable computing device; and because the establishment may define the media menu from which customers may select, the establishment maintains control over the set of media that may be played, under patron control, within the establishment.

In an exemplary embodiment, password protection may be provided to ensure that only authorized customers of a localized physical establishment may make musical media selections for that establishment. In some such embodiments, the passwords are updated hourly, daily, or weekly, within an establishment to ensure that customers making selections for that establishment have been present within the physical bounds of that establishment within the password update interval. In an exemplary embodiment, the password may be updated visually, for example on a printed menu or printed board, for viewing by customers within the establishment. In a more advanced embodiment the password may be conveyed electronically to the portable wireless portable computing devices of current customers of an establishment through a local wireless communication link.

Where necessary, computer programs, algorithms and routines are envisioned to be programmed in a high level language object oriented language, for example Java™, C, C++, C#, CORBA, Visual Basic™. Database components may utilize any common database program, by way of example and not limitation, ORACLE™, Sequel Server™, MySQL™, SQL™, MS ACCESS™, DB2™, MS FOXBASE™, DBASE™, PostgreSQL™ and RBASE™.

For purposes of this specification, the term “program” is intended to be interpreted in its broadest sense to include all instructions executable by a processor whether embodied in hardware or software. Where applicable, references to various programs may be made in both singular and plural form. No limitation is intended by such grammatical usage as one skilled in the art will appreciate that multiple programs, objects, subprograms, subroutines, algorithms, applets, contexts, etc. may be implemented programmatically to implement the various inventive embodiments.

In various exemplary embodiments, unique media identifiers are assigned to each media file that may be added to a playlist queue, the unique media identifiers identifying the particular media file which is generally a particular song by a particular artist. In addition, unique establishment identifiers for each enabled local establishment are assigned to each unique restaurant, bar, club, or gym, within the real physical world. In some exemplary embodiments, a unique identifier may be assigned to each separable venue within a single establishment that has separately playing public media, for example each separate dining room within a single restaurant that has separately playing music. In such exemplary embodiments, each dining room within the restaurant, each serviced by its own separate media player for public media play, is treated as a separate establishment for the purposes of this disclosure.

Lastly, unique customer identifiers are assigned to each customer authorized to use the collaborative media file selection arrangements described herein. In some exemplary embodiments, the unique customer identifier may be uniquely defined for use by the media server. In other exemplary embodiments, the unique customer identifier may be an existing identifier such as a unique phone number, text messaging address, or other electronic address that is unique to each user and/or is unique to the personal wireless computing device of each user.

In an exemplary embodiment, an establishment provides a printed menu of at least a portion of the pool of media files available for selection by customers within the establishment. The media menu generally includes a listing of available media selections (i.e. songs) for that establishment, each identified by the title of the song, the artist of the song, and a unique coded identifier for the song. The media menu may be printed as a sheet, flip book, menu, placemat, poster, or other convenient printed form that can be placed on tables or posted on walls of the establishment. In addition, other information may be provided on the printed media menu, for example, the album of that media file, and a date for that media file. In this way, each table within the establishment may be provided with a visual menu of a plurality of available media files from which the customer may select along with the unique coded identifier that the user may use to select that particular media file.

A customer may then view the unique identifier value associated with a media file that he or she desires to select for public play within a particular establishment, enter it into his or her portable computing device as a means of selecting it, and then send a wireless communication message to the media server indicating a desire to play that particular media file within the particular establishment. In this way, the media server may add that particular media file to the pending playlist queue for that particular localized physical establishment. It should be noted that while the printed menu of media files is described above as being located upon each table, it may also be printed or otherwise visually displayed upon walls, floors, or other surfaces of the establishment. It may be displayed as printed media or as an electronically projected media.

In some exemplary embodiments, the menu of available media files is sent electronically to the portable computing device of customers over a wireless communication link. In some such exemplary embodiments, a customer may enter a unique establishment identifier into his or her portable computing device, the code identifying the unique establishment that he or she has just entered. In some such exemplary embodiments, the customer may be required to enter a unique password for that establishment as well.

In response to entering the unique establishment identifier, the portable computing device may then download all or part of the menu of media files that are available for selection within the particular establishment and view them upon a display associated with the portable computing device. In some exemplary embodiments, the unique establishment identifier is automatically received by the portable computing device over a wireless link, via an RFID tag, or by scanning a barcode within the establishment.

For embodiments in which part or all of a media menu for a particular establishment is downloaded to the portable computing device of a patron, the patron may view the menu in an electronically displayed form upon a screen of the portable computing device. The patron may then select one or more media file from the electronic media menu using traditional graphical user interface (GUI) interactions. In this way, a customer may enter an establishment, receive a unique identifier and/or password for that establishment (either visually or electronically), and using that unique identifier and/or password may download a menu of acceptable media files for that localized physical establishment.

The customer may then select one or more media files from that menu of media files. An indication of the selection is sent to the media server, generally along with the unique identifier and/or password for that particular establishment. The media server may then add that media selection to the playlist queue for that particular localized physical establishment. The media server may also charge the requesting customer for the selection, for example charging the customer 25 cents or debiting the customer one or more pre-paid credits from a customer account.

A return message may then be sent by the media server back to the portable computing device of the requesting user, for example as a text message, comprising a receipt and/or other confirmation of the selection and/or billing transaction. The return message may include, for example, a textual indication of the song that was selected and the establishment that it was selected for. The return message also include an numeric indication of how many pending songs are ahead of that patron's selected song as currently stored in the pending playlist queue for the particular establishment. In some exemplary embodiments, the billing may be accomplished through the return message using a reverse billing SMS messaging billing processes that is implemented through the sending of the return message. In some exemplary embodiments, the localized physical establishment receives an apportioned amount of the billed price. In this way, a localized physical establishment may have a monetary incentive to enable such a service within their establishment (i.e. their restaurant, bar, gym, or club).

In some exemplary embodiments, the media server streams music to a media player of the establishment for play through the speakers of the establishment based upon customer music selections conveyed over a wireless communications link from portable computing devices on the person of the customers. In other exemplary embodiments, the media server sends unique media identifiers to a media player of the establishment, the media player then locally accesses the appropriate media file associated with the unique media identifiers and then plays the selections through the speakers of the establishment. Such a configuration may provide greater flexibility because it enables a single media server to coordinate separate media play for each of a plurality of separate establishments without the burden of streaming separate media files to each of the plurality of separate establishments. In either embodiment, a media player of an establishment is operative to play a sequence of media files to the customers of the establishment based upon a playlist queue generated in response to customer media suggestions conveyed over a wireless communications link from portable computing devices on the person of the customers.

In this way, a plurality of current customers of a localized physical establishment may collaboratively compose a playlist queue of media files to be played in the establishment, each using their own individual portable computing device (i.e. phone). In some exemplary embodiments, the playlist queue may be composed in the order in which the selections are received by the media server from the customers.

In some exemplary embodiments, an establishment may define or otherwise maintain a supplementary playlist queue for periods of time when there are no currently playing or currently pending customer-selected media files. During such periods of times, media files may be selected from a supplementary playlist queue of the establishment.

The media server may automatically select media files from the supplementary playlist queue when there are no customer-selected media files pending for play. In alternate exemplary embodiments, an automatic selection mechanism may be employed for randomly or intelligently selecting media files from a pool of media files during periods of time when there are no currently playing or pending customer-selected media files.

Such mechanisms enable media files to be seamlessly played during periods when customers do not select media files. Advanced mechanisms for automatic media selection are disclosed in co-pending patent applications by the present inventor and have been incorporated by reference herein as described in the Cross Reference Section of this disclosure. In some exemplary embodiments, the media menu is updated regularly, excluding media files that are currently pending upon a playlist queue for that establishment and/or excluding items that have recently played within the establishment, for example have played within the last 3 hours. This prevents a customer from selecting a media file that has already been selected by another customer and is currently pending play (or has recently played within the establishment.)

In other exemplary embodiments, customers are enabled to select a media file that is currently pending for play in an identified establishment. Rather than the repeat-selected media file being added again to the playlist queue for the identified establishment, the routines of the media server are enabled to move the repeat-selected media file upward towards the top of the playlist queue, bypassing other media files that were previously selected but not repeat-selected. In this way, multiple customers independently selecting the same media file for play within the same establishment within a close time proximity, has the effect of increasing the priority of that media file within the currently pending playlist queue for that establishment. In some such exemplary embodiments, each additional time that a customer selects the same media file for play within the same establishment while it is pending upon a current playlist queue for that establishment, the priority level for that media file is increased and the media file is moved higher upon the pending playlist queue.

Such a configuration has the social effect of enabling a plurality of separate customers to collaboratively move a selected media file higher upon a pending playlist queue for an identified physical establishment. In some such exemplary embodiments, each customer who submitted an independent request for the prioritized media file is charged a fee upon play of the media file. This arrangement has the benefit of enabling a novel billing method in which a plurality of separate customers are each independently charged for the singular play of the same musical media piece within the same establishment. For example, if three customers independently request the same media file for play within the same establishment at a particular time, the repeat-selected media file is prioritized in response to having been selected multiple times, is moved up in the playlist queue ahead of previously selected songs that were not repeat-selected, and upon play, each of the three customers are each independently charged a selection fee for the media file. This, for example, earns three credits for the play of the media file rather than earning just one.

In some exemplary embodiments, the menu of media files available for play within a particular establishment may be configurable by an owner or operator of the establishment through a selection process engaged with the media server. For example, an owner or operator may identify a set of 500 songs that are available for selection by customers of the establishment. This set of songs may be defined as a data file stored upon the media server that is relationally associated with the particular establishment.

This set of songs may be changed daily by the establishment to create variety in what is available for play within the establishment. This set of songs may also be updated regularly to include new music and remove old music. In this way, the media server enables a highly flexible definition of the set of songs that are available for selection by the customers of the establishment. In addition the owners and/or operators may print the current set of songs in a menu format for placement on the tables of the establishment. In this way, customers may view the current menu of available media in a convenient form, the printed menu including a unique identifier associated with each media file as described previously.

In some exemplary embodiments, a plurality of different media menus is distributed throughout an establishment, each with a different set of available musical media. In this way, a plurality of customers may view different portions of the total pool of available media within the particular establishment. This is particularly convenient in establishments where there is limited space to display printed media menus and yet a large pool of media is available for play.

In some exemplary embodiments, a media menu may be provided that also includes a unique artist identifier for each of a plurality of media artists such as singers and musical groups. In such embodiments, a user may send an artist-specific media request to the media server that includes the unique artist identifier of a desired artist as well as a unique establishment identifier for the target establishment. In response to receiving such an artist-specific media request, the media server may be configured to select at random, or through another automatic process, a media file from the current media menu of the identified establishment that is performed by the artist corresponding to the unique artist identifier.

In this way a customer may send a request to the media server, indicating for example, a desire that a Bruce Springsteen song be played within a particular establishment by sending an artist-specific media request that includes the unique artist identifier of Bruce Springsteen and the unique establishment identifier of the particular establishment. The media server, upon receiving the request, may be configured to select a Bruce Springsteen song at random from the pool Bruce Springsteen songs currently available for play within the particular establishment (i.e. from the pool of Bruce Springsteen songs currently on the media menu for that establishment), and add the randomly selected song to the current playlist queue for the particular establishment.

In some exemplary embodiments, the customers of an establishment may view the currently pending playlist queue, or a portion thereof, for that establishment upon their wireless computing device. In some such exemplary embodiments, the customer of an establishment may enter the unique identifier (and/or password) for the establishment into his or her portable computing device or receive the unique identifier (and/or password) automatically upon his or her portable computing device when within the establishment through for example Wi-Fi, Bluetooth, and/or cellular telephone communication links.

The portable computing device may then send the unique identifier (and/or password) for the localized physical establishment to the establishment media server which in response sends the current playlist queue, or a portion thereof, for that establishment to the portable computing device of that customer. The playlist queue may then be displayed upon a screen of that portable computing device, allowing the customer to see which songs, how many songs, and what order of songs, are currently pending for play within the establishment.

The customer may then review the media menu for that establishment as he or she decides whether or not to add a song to playlist queue and/or what song to add. Thus, the customer may download from the media server the current pending playlist queue as well as listing of available songs from which to select. In some exemplary embodiments, the currently pending playlist queue may also be downloaded by a computer of the establishment and may be presented upon a screen of the establishment, for example a screen above a bar and/or at other convenient locations for viewers to view.

In some exemplary embodiments, a customer may download an establishment specific media menu by sending an encoded message to the media server including the establishment identifier for the establishment for which a media menu is desired as well including a menu request identifier. For example, in one embodiment a customer may download an establishment specific media menu by sending a text message to the media server including the menu request identifier “MENU” followed by the unique establishment identifier code for the establishment for which the media menu is desired.

Similarly, in some exemplary embodiments a customer may download an establishment specific playlist queue by sending an encoded message to the media server including the establishment identifier for the establishment for which a media menu is desired as well including a playlist request identifier. For example, in one embodiment a customer may download an establishment specific playlist queue by sending a text message to the media server including the playlist request identifier “PLIST” followed by the unique establishment identifier code for the establishment for which the playlist is desired.

Similarly, in some embodiments a customer may receive an establishment specific playlist length from the media server by sending an encoded message to the media server including the establishment identifier for the establishment for which a media menu is desired as well including a playlist length request identifier. For example, in one embodiment a customer may download an establishment specific playlist queue by sending a text message to the media server including the playlist length request identifier “L” followed by the unique establishment identifier code for the establishment for which the playlist is desired. The media server responds by reporting the number of currently pending songs in the playlist queue for the identified establishment to the requesting customer's portable computing device. In some embodiments the media server responds by reporting the total play time of currently pending songs in the playlist queue for the identified establishment to the requesting customer's portable computing device.

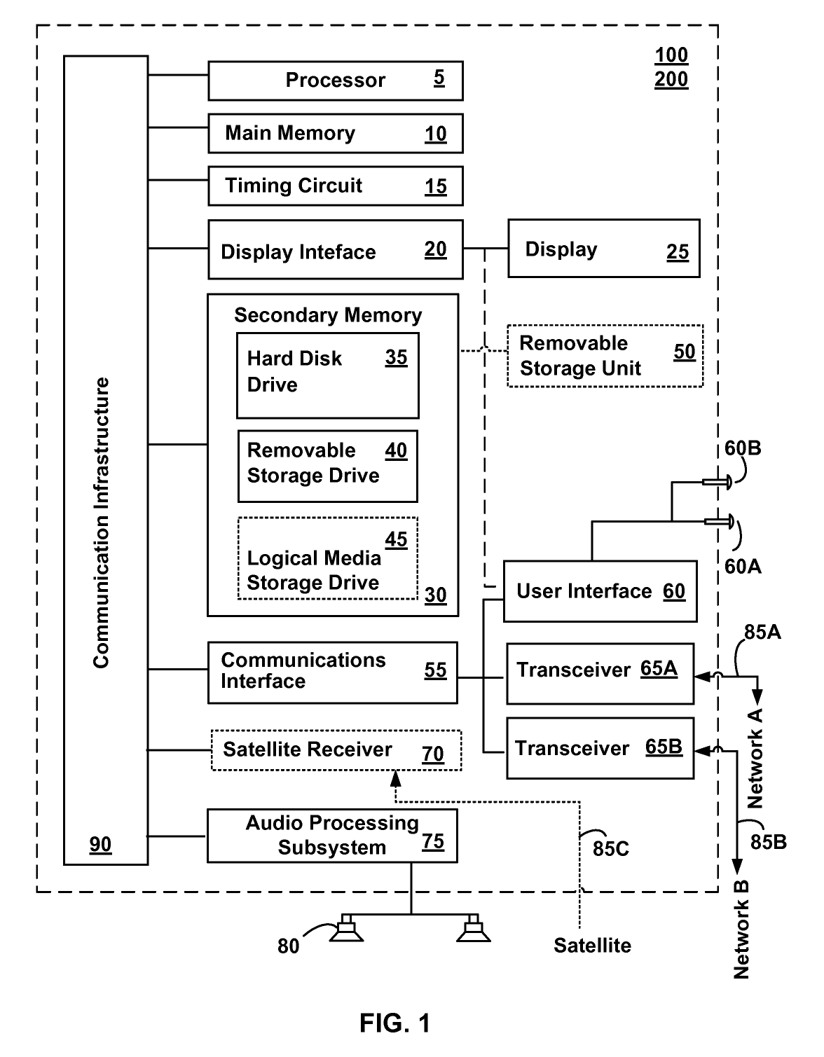

Referring to FIG. 1, a generalized block diagram of a computer system 100 is depicted. The computer system 100 may be configured as an establishment media player that plays media to customers within an establishment in response to data received from a media server. The computer system 100 may also be configured as a media server that receives wireless messages from customers within one or more establishments and coordinates media play within the one or more establishments. The computer system 100 may also be configured as a portable computing device used by each of the customers to select media files and exchange data with the media server. The computer system 100 includes a communications infrastructure 90 used to transfer data, memory addresses where data files are to be found and transfer control signals among the various components and subsystems associated with the computer system 100.

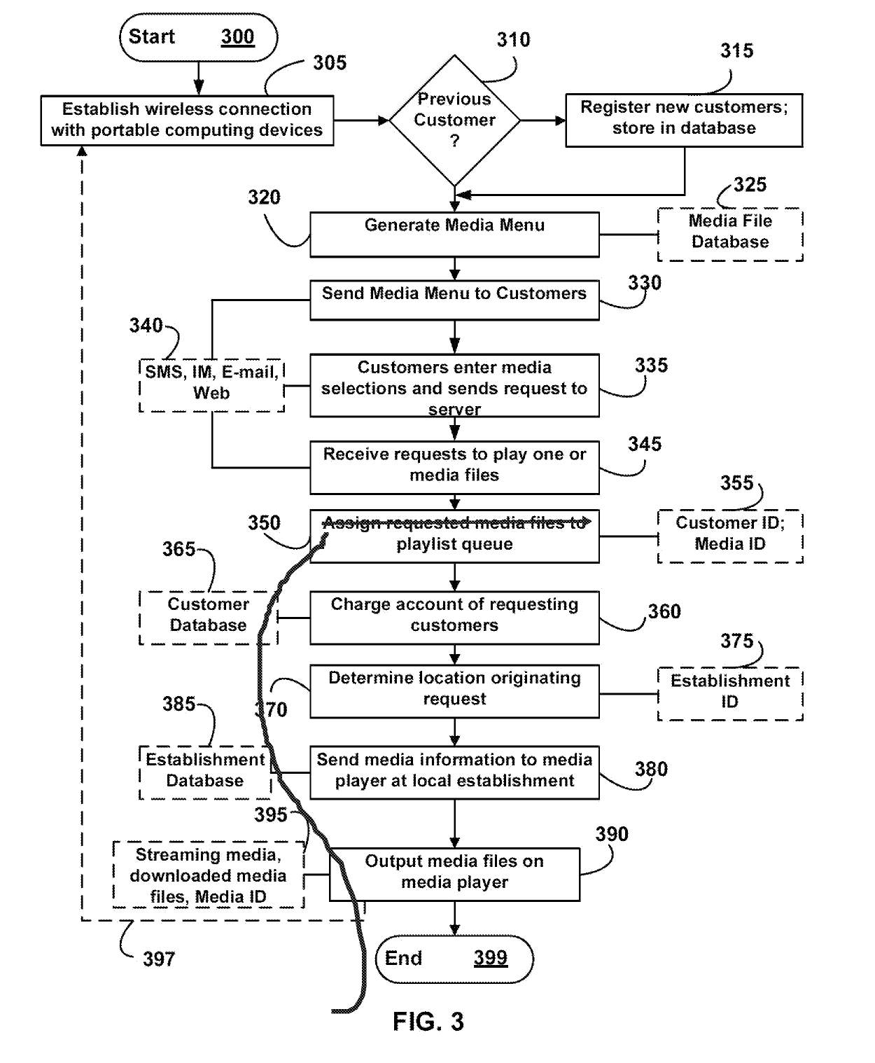

A processor 5 is provided to interpret and execute logical instructions stored in the main memory 10. In one exemplary embodiment, the processor 5 may be of a general purpose type commonly associated with desktop computer systems. In another exemplary embodiment, the processor 5 may be application-specific integrated circuit (ASIC) which is programmed to perform a particular function. In this exemplary embodiment, an ASIC processor may be used to output audio played media or control portable computing devices, for example cellular telephones. In an exemplary embodiment, the processor 5 is programmed to execute the processes described in FIG. 3.

The main memory 10 is the primary general purpose storage area for instructions and data to be processed by the processor 5. The term “main memory” 10 is used in its broadest sense and includes RAM, EEPROM and ROM. The main memory 10 is a type of computer readable storage media.

A timing circuit 15 is provided to coordinate activities in near real time. The processor 5, main memory 10 and timing circuit 15 are directly coupled to the communications infrastructure 90.

A display interface 20 may be provided to drive a display 25 associated with the computer system 100. The display interface 20 is electrically coupled to the communications infrastructure 90 and provides signals to the display 25 for visually outputting both graphical displays and alphanumeric characters. The display interface 20 may include a dedicated graphics processor and memory to support the displaying of graphics intensive media. The display 25 may be of any type (e.g., cathode ray tube, gas plasma) but in most circumstances will usually be a solid state device such as liquid crystal display.

A secondary memory subsystem 30 is provided which houses retrievable storage units such as a hard disk drive 35, a removable storage drive 40, an optional logical media storage drive 45 and an optional removal storage unit 50. One skilled in the art will appreciate that the hard drive 35 may be replaced with a flash memory drive.

The removable storage drive 40 may be a replaceable hard drive, optical media storage drive or a solid state flash RAM device. The logical media storage drive 45 may include a flash RAM device, an EEPROM encoded with playable media, or optical storage media (CD, DVD). The removable storage unit 50 may be logical, optical or of an electromechanical (hard disk) design. The secondary memory subsystem 30 is another type of computer readable storage medium. A communications interface 55 subsystem is provided which allows for standardized electrical interfacing of peripheral devices to the communications infrastructure 90 including, networking, serial, parallel, USB, and Firewire™ connectivity. For example, a user interface 60 and two transceivers 65A,B are electrically coupled to the communications infrastructure 90 via the communications interface 55. For purposes of this specification, the term “user interface” 60 includes the hardware and operating software by which a customer interacts with the computer system 100 and the means by which the computer system 100 conveys information to the customer and may include the display interface 20 and display 25.

In an exemplary embodiment, the computer system 100 may be configured as a media player that is outputting music to customers in proximity to a physical establishment such as a restaurant, bar, coffeehouse, or gym. In this exemplary embodiment, the user interface 60 is generally configured by restaurant employees; for example adjusting the sound volume being outputted by the computer system 100. The customer interface 60 employed on the computer system 100 may include a pointing device (not shown) such as a mouse, thumbwheel or track ball, an optional touch screen (not shown); one or more push-button switches 60A, 60B; one or more sliding or circular potentiometer controls (not shown) and one or more other type switches (not shown.) The user interface 60 provides interrupt signals to the processor 5 that may be used to interpret customer interactions with the computer system 100 and may be used in conjunction with the display interface 20 and display 25. One skilled in the art will appreciate that the user interface devices which are not shown are well known and understood. In this way, establishment employees may interact directly with the computer system 100 and input configuration information.

The first transceiver 65A facilitates the remote exchange of data and synchronizing signals between the computer system 100 and other devices in processing communications 85A with the computer system 100. The first transceiver 85A is intended as a general purpose networking transceiver which is generally compatible with IEEE networking standards for example, 802.11, 802.16, 802.22. Alternately, digital cellular communications formats compatible with for example GSM, 3G, CDMA, TDMA and evolving cellular communications standards. Both peer-to-peer (PPP) and client-server models are envisioned for implementation of the invention. The second transceiver 65B is intended as a short range transceiver for example, a Bluetooth™ transceiver or an RFID scanner and a local wireless network. In a third alternative embodiment, the transceiver 65A may include hybrids of computer communications standards, cellular standards and evolving satellite radio standards, as well as via a public switched telephone network (PSTN.)

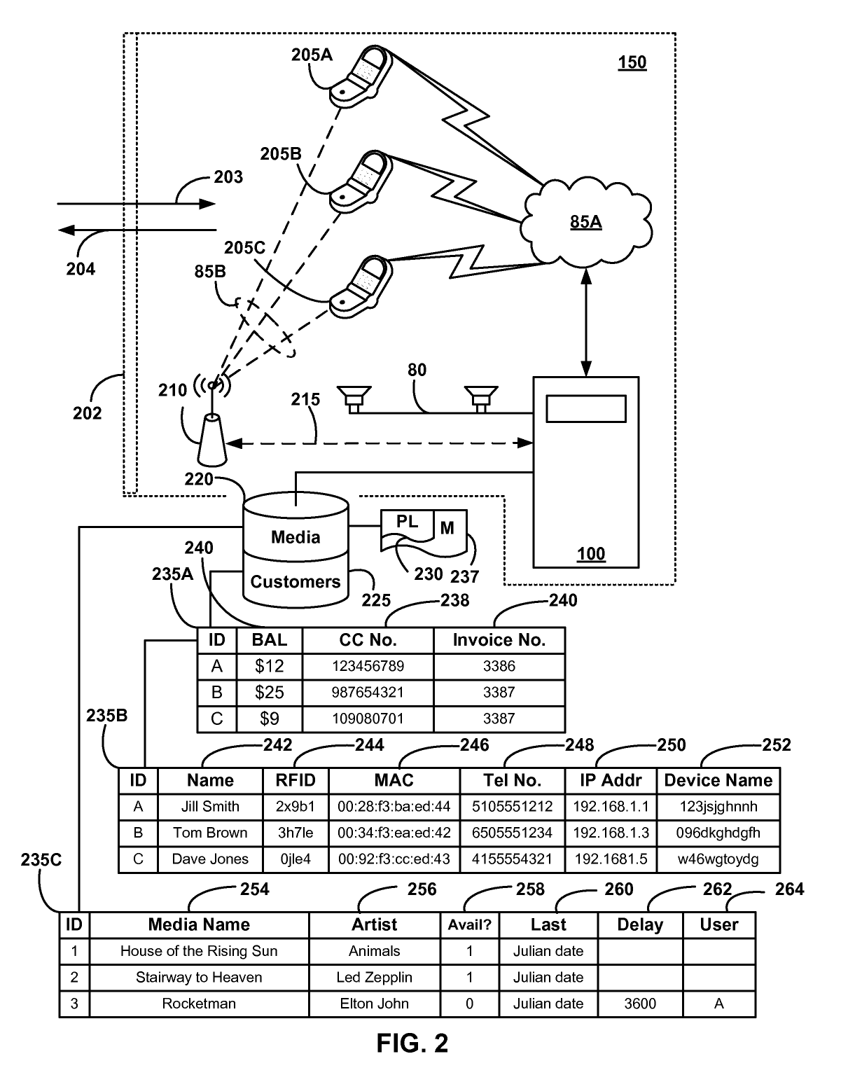

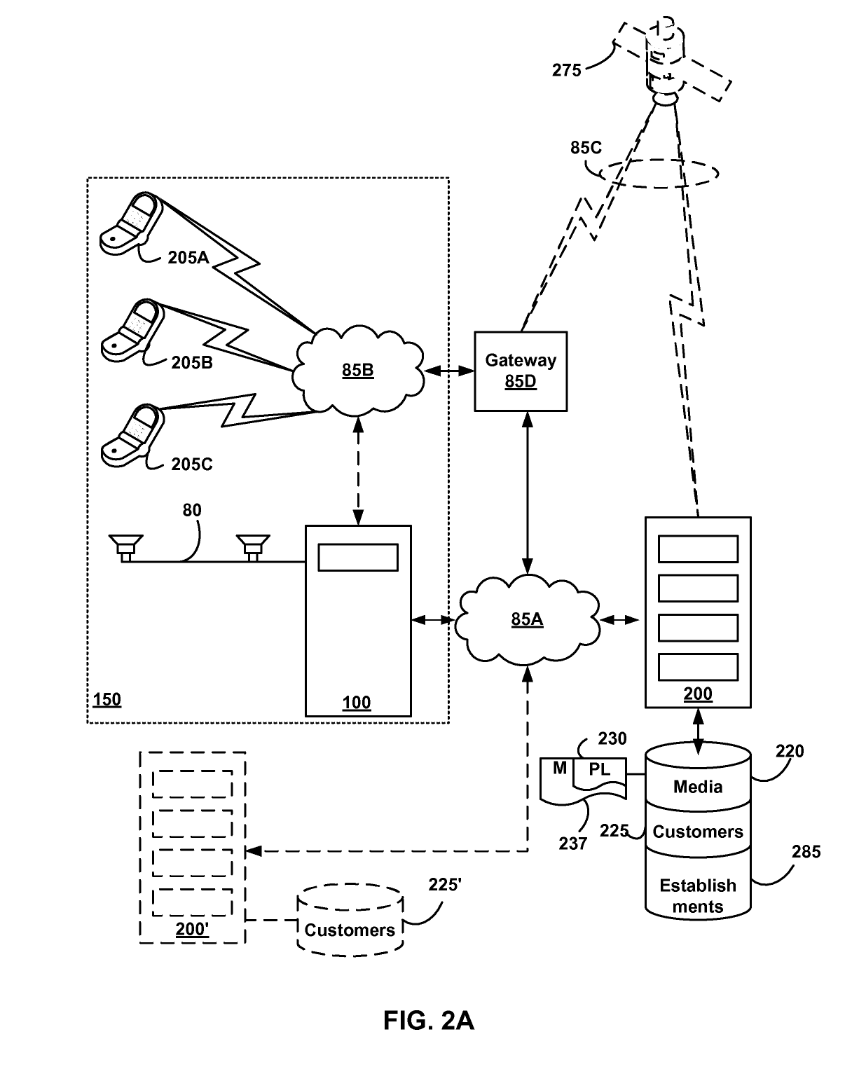

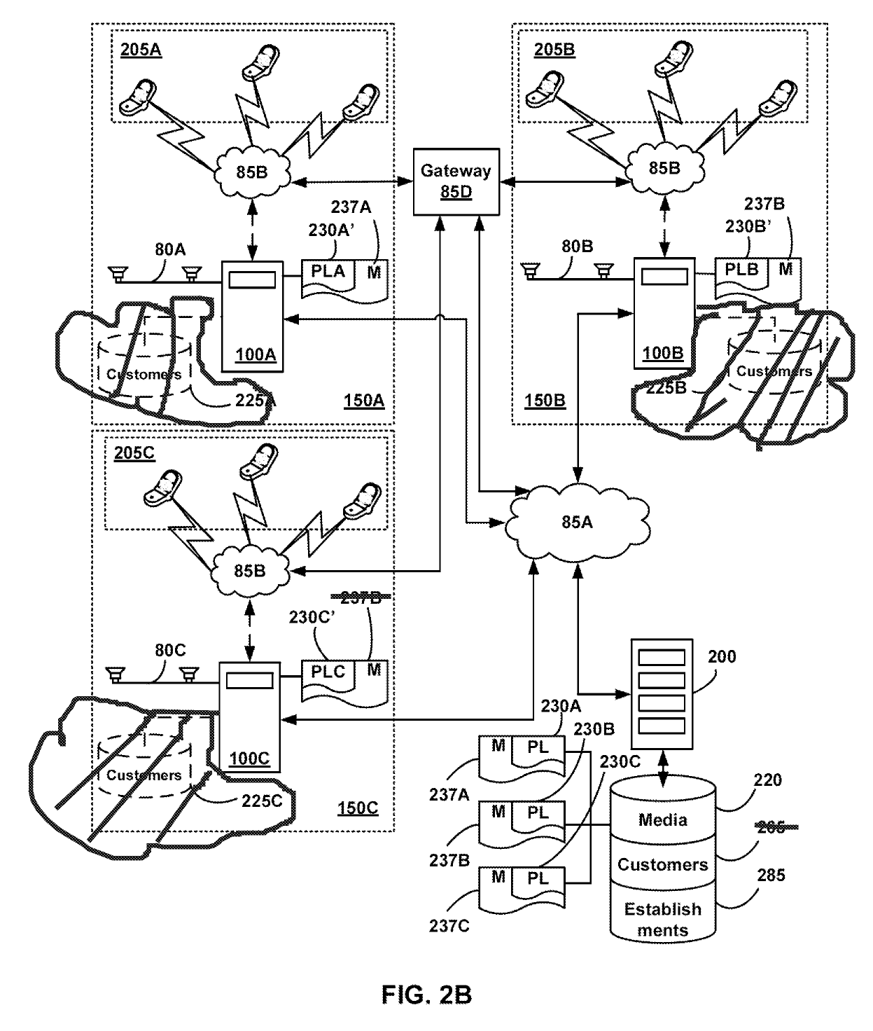

The second transceiver has a shorter range than the first transceiver 65A; the second transceiver 65B may be used to determine which customers are actually present in an establishment. In this exemplary embodiment, the second transceiver 65B is generally a Bluetooth™ or infrared transceiver. In another exemplary embodiment, the second transceiver 65B is incorporated into a radio frequency identifier (RFID) scanner. In this exemplary embodiment, the RFID scanner determines which customers are present based on transponded identifier codes. The RFID scanner may be disposed at a portal 202 (FIG. 2) of the establishment and may be used to track customers entering and leaving the establishment. In such exemplary embodiments, an RFID tag is present on the person of each customer, the tag encoded with a unique identifier for that customer and/or for the portable computing device of that customer.

Alternately, an RFID scanner may be employed within or upon the portable computing devices of customers. In such exemplary embodiments, one or more RFID tags may be positioned within establishments that include the unique identifier for the establishment. In this way, a portable computing device of a patron may automatically access the unique identifier of an establishment to which the patron is locally present. Barcodes may be used as well, an bar code scanner and/or a camera configured to act as a bar code scanner, of the portable computing device, being used to scan barcodes within an establishment that encode the unique identifier of the establishment.

In an optional exemplary embodiment, a satellite receiver 70 is operatively coupled to the communications infrastructure 90. The satellite receiver 70 is configured to receive signals 85C. A more detailed discussion is provided below accompanying the discussions provided for FIGS. 2, 2A and 2B

In an exemplary embodiment, the computer system 100 may be configured as a local media server and/or a media player (FIG. 2). In another exemplary embodiment, the computer system 100 may be configured as a remote media server 200 (FIG. 2A) that is maintained by a third party service provider and located offsite from the establishment. In this exemplary embodiment, the media player 100 communicates with the media server 200 over a communication network such as the Internet 85A. In general, the media server 200 is configured to service a plurality of physical establishments, each with its own local media player 100 that communicates with the media server 200 over a communication network such as the Internet 85A.

The communication link 85A may be wired, wireless, or a combination of wired or wireless. The first transceiver 65A may also facilitate the remote exchange of data between the local media player 100 and a plurality of portable computing devices 205A,B,C associated with customers and generally containing personal data about that customers. In various exemplary embodiments, the plurality of portable computing devices 205A,B,C communicate over a wireless communication link such as a cellular network 85B, to the media server 200. In an exemplary embodiment, the cellular network 85B is connected to a public packet switched network 85A via a gateway 85D operated by the cellular provider or another third party provider.

Lastly, the local media player 100 includes an audio processing subsystem 75. The audio processing subsystem 75 is electrically coupled to the communications infrastructure 90 and provides for the output of media, for example, multi or multimedia encoded in any of the exemplary formats MP3, AVI, WAV, MPG, QT, WMA, AIFF, AU, RAM, RA, MOV, MIDI, etc. The audio processing subsystem 75 is operatively coupled to one or more audio output devices, generally speakers 80. The speakers 80 may be disposed in various locations within the establishment to optimize acoustics. The speakers 80 may be coupled to the audio processing subsystem 75 by traditional cabling and wireless arrangements such as Bluetooth™. In addition, the audio processing subsystem 75 is envisioned to optionally include features such as graphic equalization, volume, balance, fading, base and treble controls, surround sound emulation, and noise reduction. One skilled in the art will appreciate that the above cited list of file formats is not intended to be all inclusive.

The media player 100 includes an operating system, the necessary hardware and software drivers necessary to fully utilize the devices coupled to the communications infrastructure 90, media playback, data access routines for sending and/or receiving data from the media server 200 and/or from the portable computing devices 205A,B,C.

Referring to FIG. 2, an exemplary block diagram is depicted in which a computer system 100, configured as a local media server is in processing communications over at least one network 85A with a plurality of wireless portable computing devices 205A,B,C. For simplicity and ease of understanding, the computer system 100 will be referred to herein after as a media player 100.

In a first exemplary embodiment, the network 85A is one or more public networks connected together by various gateways 85D (FIG. 2A.) For example, cellular telephone networks with a gateway to the Internet. In this exemplary embodiment, the plurality of wireless portable computing devices 205A,B,C comprise intelligent cellular telephones which are configured to send and receive short messaging service (SMS) or instant messaging (IM) text messages to the media player 100. In order to communicate with the media player 100, the establishment 150 provides instructions to the customers with an address of the media player 100. The address may be an SMS address, IM address, “short code”, phone number, handle or other unique identifier which is accessible over the public network 85A. Using the address provided by the establishment 150, each customer sends a message from their portable computing devices 205A,B,C to the media player 100.

Customers who are new to the establishment, or have changed identifying information may be prompted to fill out a brief registration request sent by the media player 100. The registration information is stored in a customer database 225. Established customers and those who have completed the brief registration process may then be provided a media menu 230 of media 220 available for selection and play by the media player 100. The registration process may include the customer's name 242, RFID code 244, media access control code 246 of the portable computing device, the customer's telephone number 248, internet protocol address 250, a device or customer name 252. Each portable computing device 205A,B,C is associated with a unique device identifier 235B.

The registration process may also include a credit or debit card number 238 which allows the establishment 150 to charge the customer for utilizing the collaborative selection service. In an exemplary embodiment, the charges may be added to an invoice 240 of the establishment 150. For example, charges for using the collaborative selection service may be added to a balance 240 for meals and drinks. In such exemplary embodiments, the user may enter a unique table number, seat number, or other locative identifier with respect to the establishment, into his or her portable computing device, as a way of associating that user with a pending bill food and drink services.

In many exemplary embodiments, charges for media selections are billed using a reverse billing SMS process that adds the charge the user's existing phone bill as associated with his or her personal portable computing device 205A, 205B, 205C. In an alternate exemplary embodiment, an alternate SMS billing process such as PayPal™ may be employed as well.

The media menu 237 includes the media names 254 that are currently available for play in the establishment. To simplify the selection process, the media files 254 may be selected by entering a unique code 235C associated with each media file 254. The media menu 237 may also include such information as the name of the artist 256, whether the selection is still available 258 (i.e., not already selected by another), the last time the media file was played 260, a predetermined delay 262 to inhibit replay of a recently played media file 254 and optionally the customer identifier 264 who selected the media file for play. A playlist queue 230 may also be provided which contains those media files 220 pending to be played by the media player 100.

Each customer entry may also be indexed using a unique identifier 235A which allows cross referencing of a customer's information among a plurality of data tables. Once the media files have been selected, the media player 100 plays the selected media files from the playlist queue 230 which are output to the audio output devices 80. In general selected media files are added to a playlist queue of pending media files which are played in sequential order by the media player 100 which acts dually as an establishment media player.

In a second exemplary embodiment, the network 85A is a local wireless network, for example, an IEEE 802.11a,b,g,n operated by the establishment. As previously described, the plurality of wireless portable computing devices 205A,B,C comprise intelligent cellular telephones which are configured to send and receive short messaging service (SMS), E-mail or instant messaging (IM) text messages to the media player 100. In order to communicate with the media player 100, each of the wireless portable computing devices 205A,B,C establish communications over the local network 85A with the media player 100. However, unlike the public network embodiment described above, much of the unique device identifier 235B information is incorporated into the wireless communications protocols. For example, the RFID 244, the MAC 246, assigned IP address 250 and device name 252 are parameters normally available over IEEE 802.11a,b,g,n conforming wireless networks.

For new customers or customers with information changes, an analogous registration process may be performed to populate the required information of the customer database 225. The selection and playing of musical media files is accomplished as before using SMS, E-mail IM text messaging, or other forms of electronic messaging.

In an exemplary embodiment, a second communications link 85B is provided. In this exemplary embodiment, the second communications link 85B is a Bluetooth link coupled 215 to the media player 100. In this exemplary embodiment, the Bluetooth link 85B may be used as a local proximity sensor 210 disposed at a portal 202 of the establishment 150. Since the Bluetooth protocol is intended as a short range communication link 85B, the presence or absence of a Bluetooth signal may be used to determine which customers are present within the establishment 150.

In addition, the Bluetooth link 85B may also be used to send and receive electronic messages between the portable computing devices 205 ABC, and the media player 100 as is described above for the wireless network 85A. In this exemplary embodiment, the transceiver 210 may be installed within the localized physical establishment 150 to detect the presence of the portable computing devices 205A,B,C when they are within a certain area 202 associated with the establishment. In this way, the media player 100 may automatically register customers as they ingress 203 into the establishment 150 and unregister customers as they egress 204 the establishment. Ingressing 203 customers would automatically receive the establishment's media menu 230 communicated by the media player 100 over the Bluetooth link 85B or wireless network 85A.

In another exemplary embodiment, the second communications link 85B is an RFID transponder signal. The sensor 210 may comprise an RFID scanner. In this exemplary embodiment, new customers are provided with a small RFID tag which may be affixed to their portable computing devices 205A,B,C by an adhesive sticker. The new customer then registers his or her portable computing devices 205A,B,C over the wireless network 85A as previously described. Once registered, returning customers may be automatically detected when ingressing 203 through a portal 202 and unregistered when egressing 204 the portal 202, analogous to the Bluetooth arrangement described above. The RFID scanner 210 outputs 215 the detected unique identifier of each RFID tag detected to the media player 100. The media player 100 identifies the customer associated with the unique identifier. The customer information stored in the customer database 225 is then used to send the establishment's media menu 230 over the wireless network 85A to the customer's portable computing devices 205A,B,C.

In alternate exemplary embodiments, the RFID scanners are integrated into the portable computing devices 205A,B,C and the RFID tag is affixed to a location within the establishment. In such an exemplary embodiment, the portable computing devices 205A,B,C are configured to automatically detect the unique identifier of an establishment that is entered by scanning the RFID tag that is physically associated with the establishment. The unique establishment identifier is thereby read by the portable computing devices 205A,B,C.

Referring to FIG. 2A, an exemplary block diagram is depicted in which media player 100 is in processing communications over at least one network 85A with a remote media server 200. In addition, the media server 200 is in processing communications over at least one network with a plurality of wireless portable computing devices 205A,B,C, typically be means of a gateway 85D. In some optional exemplary embodiments, the portable computing devices 205A,B,C may also be configured to communicate directly with the media player 100 over a local wireless network 85B and/or with an alternate local wireless network that acts as a gateway to a public network 85A such as the Internet. In an exemplary embodiment, the media player 100 is configured to receive playlist data, unique media identifiers, and/or streaming media from the media server 200 based upon selections received by the media server 200 from the portable computing devices 205A,B,C.

In an exemplary embodiment, the musical media files are stored locally to the media player 100, and is accessed and played by the media player in response to unique media identifiers received from the media server 200 over the communication network 85A. In this way, the media server 200 is operative to orchestrate the local play of the media files by the media player 100. In an exemplary embodiment (FIG. 2B) the media server 200 is operative to independently orchestrate the local play of media content by a plurality of separate establishment media players 100A,B,C, each associated with a separate localized physical establishments maintained in a database 285 accessible by the media server 200. In this way, a plurality of establishment media players 100A,B,C, each associated with a unique establishment 150, may independently play musical media that has been uniquely selected by customers of that establishment 150, under the coordination of a centralized media server 200.

In such an exemplary embodiment, the local establishment 150 is not directly involved in moderating the selection of media files or handling billing transactions associated with the selection of media files. Instead the media player 100 may be configured to output 80 musical media under the coordination of the media server 200 which moderates the selection process among customers and coordinates any associated billing transactions. In some such exemplary embodiments, each customer establishes an account with a third party provider which operates the media server 200. Each customer's account is maintained in a remote database 225 as are the media files for selection 220. Upon arriving at a properly configured establishment 150, each customer wishing to select media for public play within the establishment 150 sends an electronic message, for example an SMS text message, using their portable computing devices 205A,B,C, to the media server 200.

The electronic message includes a unique identifier associated with the establishment 150 as well as a unique identifier 235C associated with each media file that the customer desires to have played within the establishment. In this way, the media server 200 receives an indication that a particular customer, generally identified by the electronic address of their portable computing device (i.e. their phone number or text messaging address), desires that a particular song (identified by a unique media identifier), be played in a particular establishment (identified by a unique establishment identifier). The media server 200 then adds the selected song to the currently pending playlist queue 230 of the identified establishment 150. In some exemplary embodiments the media server 200 may be configured to send a media menu 237 of available media files for a particular identified establishment 150 to a requesting portable computing devices 205A,B,C.

In an exemplary embodiment, the media menu 230 may be a subset of all available media files 220 in the database which has been customized for the particular identified establishment 150 to limit customer selections to media files suitable for play within that establishment 150. For example, the media menu 230 for a particular establishment 150 may be limited to a genre, screened for adult content, limited in length of play, screened for recently played media files, etc. In this way, each unique establishment 150 may define a unique media menu 230 that defines the pool of media selections available for play within that establishment. In some such exemplary embodiments, the media menu may not be sent electronically to customers, but instead may be provided in printed form, for example on tables, as described previously.

In this way, an establishment such as a restaurant or gym may prevent customers from selecting inappropriate media files for play in that establishment. For example, a limited menu 237 may be provided, either electronically or physically, to customers of the establishment such that the customers may only select media files off a limited menu 237. In an exemplary embodiment, the establishment media player 100 of each establishment 150 has access to a local data store that contains the media content of all media files that are available for selection within the media menu 230 for that particular establishment 150. In this way, the media server 200 maintains a listing 230 of all media files available for play within a particular establishment 150, the media player 100 of that establishment having locally access to it, the media content for each song on that menu 237.

When it is time to play a particular media file within a particular establishment, as determined by the playlist queue 230 for that particular establishment that is maintained upon the media server 200, a media identifier is sent from the media server 200 to the establishment media player 100 of that establishment 150. In response to receiving the media identifier, the establishment media player 100 locally accesses and plays the identified song. In this way, the media server 200 is operative to maintain a playlist queue 230 for the establishment 150 and coordinate in accordance with the playlist queue 230, the local play of media within the establishment 150 as output by the establishment media player 100 of that establishment. The playlist queue 230 for each establishment is generated, at least in part, based upon electronic messages received from portable computing devices 205A,B,C as described previously. In this way, the media server 200 is operative to enable customers to select particular songs to be added to playlist queues 230 associated with a particular establishment 150 and then coordinate the execution of by the media player local to that establishment.

In some exemplary embodiments, the media content of the customer selected media files may be streamed to the establishment media player 100 if it is not locally available to the media player 100 at the time it is required for play by a playlist queue 230 associated with that establishment 150. The streamed media content may be sent over high speed internet connections, over cellular communication connections, or streamed from a satellite 275 over a satellite communication connection 85C. In an exemplary embodiment, the remote media server 200 is coupled to another remote server 200′ over the network 85A. In this exemplary embodiment, the remote server 200′ is that of a financial services company, for example a debit or credit card transaction server where each of the customers has an established account 225′.

Referring to FIG. 2B, an exemplary block diagram is depicted in which a plurality of local establishment media players 100A,B,C are in processing communications over a network 85A with a remote media server 200, each establishment media player 100A,B,C servicing a separate localized physical establishment and being associated with a separate unique establishment identifier 150A,B,C or other unique identifier In this exemplary embodiment, each establishment enters into an agreement with a media providing service. The media providing service allows customers to select, using their own portable computing devices 205A,B,C, media files for public play within the establishment under the coordination of the media server 200.

This coordination is achieved by the media server 200 maintaining a unique media menu 230 and a unique pending playlist queue 230 for each establishment 150, the playlist 230 for each establishment being generated, at least in part, in response to customer selections received for that particular establishment from the media menu 237 for that establishment. The customer selections are sent as electronic messages from the portable computing devices 205A,B,C to the media server 200 over an intervening communication network such as a cellular network 85B. In an exemplary embodiment, the portable computing devices are cellular telephones and the electronic messages are SMS text messages that encode the unique establishment identifier 150A,B,C for which a selection is being made as well as encodes the unique media identifier that is being selected.

Each customer may then be charged for each media file requested for public play within an identified establishment. The fee may be charged upon the request being processed, or upon actual play of the identified media file within the identified establishment. In one preferred embodiment, the fee is charged upon completion of play of the identified media file within the identified establishment. Alternately, each customer may pay a subscription charge. In either case, the establishment may be provided a percentage of the fees generated as a result of media selections made for that establishment. In this way, each establishment 150A,B,C is provided with a monetary incentive to enable such a customer media selection service within their establishment (i.e. their restaurant, bar, gym, or club).

In some exemplary embodiments, an establishment 150A,B,C may define or otherwise maintain supplementary playlist queues 230A′,B′,C′ for periods of time when there are no currently playing or currently pending customer-selected media files. During such periods of times, media files may be selected from the supplementary playlist queues 230A′,B′,C′ of the establishments 150A,B,C. The supplementary playlist queues 230A′,B′,C′ for the establishments 150A,B,C may be maintained upon the media server 200 or upon the local establishment media players 100A,B,C.

In an exemplary embodiment, the remote media server 200 may generate a supplemental playlist queue for an establishment by automatically selecting media files from media menu 230A,B,C for that establishment when there are no customer-selected media files pending for play. In another exemplary embodiment, an automatic selection method may be employed for randomly or intelligently selecting media files from the pool of media menu files during periods of time when there are no currently playing or pending customer-selected media files. Such methods enable media to be seamlessly played during periods when customers do not select media files.

As previously described, some exemplary embodiments enable a customer to download the media menu 237A,B,C onto his or her portable computing device 205A,B,C and may review the menu and interactively select an item from the list. In some exemplary embodiments, the media menu is updated regularly, excluding items that are currently pending upon a playlist queue 230A,B,C for that establishment. In some exemplary embodiments, the media menus 237A,B,C are regularly updated to exclude media files that have recently played within an establishment 150A,B,C for example, having been played within the last 3 hours.

In some such exemplary embodiments, the media items that are currently excluded for selection may appear on the representation of the media menu 237A,B,C that is displayed to a user on his or her portable computing device, but may be depicted as grayed-out or otherwise be visually identified as being non-selectable at the current time. In this way, a customer may view the entire media menu 237A,B,C for a particular establishment 150 on his or her portable computing device, but is given a clear visual indicator as to which media items are currently available for selection and which are not. This assists a customer select songs that are currently available for play, while also informing the customer as to songs that may be available at other times within the establishment.

The modification of the media menu 237A,B,C of a particular establishment 150A,B,C, for example to exclude media files from selection that have recently played within that establishment 150A,B,C or to exclude media files from selection that are currently pending for play within that establishment, helps prevents a customer from selecting a media file that has already been selected by another customer and is currently pending play (or has recently played within the establishment 150A,B,C.)

In other exemplary embodiments, customers are enabled to select a media file that is currently pending for play in an identified establishment 150A,B,C. Rather than the repeat-selected media file being added again to the playlist queue 230A,B,C for the identified establishment 150A,B,C, the routines of the media server 200 are enabled to move the repeat-selected media file upward towards the top of the playlist queue 230A,B,C for that establishment, bypassing other media files that were previously selected but not repeat-selected. In this way, multiple customers using separate portable computing devices 205A,B,C may each independently select the same media file for play within the same establishment within a close time proximity and have the effect of increasing the priority of that media file within the currently pending playlist queue 230A,B,C for that establishment 150A,B,C. In some such exemplary embodiments, each additional time that a customer selects the same media file for play within the same establishment while it is pending upon a current playlist queue 230A,B,C for that establishment, the priority level for that media file is increased and the media file is moved higher upon the pending playlist queue 230A,B,C. Such a configuration has the social effect of enabling a plurality of separate customers to collaboratively move a selected media file higher upon a pending playlist queue 230A,B,C for an identified physical establishment 150A,B,C.

In some such exemplary embodiments, each customer who conveys an independent request for the play of a media file that is prioritized in response to the multiple requests is charged a fee upon play of the media file. This arrangement has the benefit of enabling a novel billing method in which a plurality of separate customers are each independently charged for the singular play of the same musical media piece within the same establishment 150A,B,C. For example, if three customers independently request the same media file for play within the same establishment 150A,B,C at a particular time, the repeat-selected media file is prioritized in response to having been selected multiple times and is thereby moved up in the playlist queue 230A,B,C for that establishment so that it plays ahead of previously selected songs that were not repeat-selected. And upon play of the media file, each of the three customers who submitted requests for the media file are each independently charged a selection fee. This, for example, earns three credits for the play of a single media file rather than just one credit.

In some exemplary embodiments, the menu of media items that are available for play within a particular establishment may be configurable by the owners or operators of the establishments 150A,B,C through a selection process engaged with the remote media server 200. For example, an owner or operator may identify a set of 500 media files that are available for selection by customers of their respective establishments 150A,B,C. One skilled in the art will appreciate that the various customizations to the media menu 230A,B,C may be accomplished at the media player level 100A,B,C as well. For example, an establishment may define different media menus for different days of the week, times of day, months of the year, or seasons of the year. An establishment 150A,B,C may also update their media menu 237A,B,C regularly based upon customer feedback, changes in pop music charts, or the release of new musical media.

Referring to FIG. 3, a process flowchart is depicted for the various exemplary embodiments disclosed herein. In an exemplary embodiment, the process is initiated 300 by establishing a wireless connection with a plurality of portable computing devices 305 and a media server. The media server determines if one or more of the portable computing devices are associated with a previous customer 310. The previous customer determination may be performed by checking the MAC, a unique device name, a digital certificate exchange, cellular telephone number, RFID identifier or other unique identifier indicia sent from the portable computing devices.

If one or more of the customers associated with the portable computing devices are new customers 310 or have changes to their current profile, registration request(s) may be sent to each new portable computing device. Alternately, a new customer data file may be automatically generated in memory without the need for the user engaging in any formal registration process. For example, if an SMS text message is received by the media server from a phone number or text messaging address that is not contained in the current customer database 365, a new entry may be made in the customer database 365 for the new user, thereby initiating that customer for usage of the media selection service.

The new entry may then be recorded in the customer database 365 coupled to the media server 310 along with a unique identifier which is used as a cross index the new customers for future use 315. In an exemplary embodiment, an electronic media menu of available media for play on the media database 325 and optionally for a particular establishment is generated 320 and sent 330 to the portable computing devices of customers who are identified as being local to the particular establishment. In an exemplary embodiment, currently selected media files and/or recently played media files may not appear for selection in the media menu generated by the server 320 or may be identified in the media menu as being currently unavailable for selection. The media menu is then sent to the portable computing device over the wireless connection 330.

Each customer then makes his or her media file selections by entering the unique media identifiers into their associated portable computing devices or selecting the media files for play from a GUI menu generated upon the portable computing device in response to the received electronic media menu 335. The media file requests are sent as electronic messages back the server, for example as SMS text messages or other messaging format 340. The media file requests 335 also include a unique establishment identifier 375 indicating the establishment for which the identified media file is desired to be played.

The media server receives the requests to play the customer selected media files 345 within the customer identified establishment. The media server then adds the selected media files 345 to the unique playlist queue 350 associated with the identified establishment. The playlist queue for the identified establishment may thereafter be updated with a received madia file request. For example, by adding each unique media file identifier corresponding to each received media request. A separate playlist queue 350 may be maintained for a plurality of separate establishments being moderated by the media server. The playlist queue for a particular establishment may be generated entirely based upon received customer requests or may be generated through a combination of received customer requests and automated media selections made by a software process.

Each entry in the playlist queue may be associated with the unique customer identifier and media identifier(s) 355, the unique customer identifier indicating the unique customer, or portable computing device of the customer, that requested the particular media item in the queue. The media server then attempts to charge each requesting customer's account 360 stored in the customer database 365. The customer database 365 may contain each customer's credit card information, a prepaid balance, pre-purchased credits amounts, and/or a reference to another credit card processing system or a running invoice which may be added to the customer's bill while in an establishment.

Alternately, a return SMS message may be sent to the customer using the phone number (or other electronic address) for the customer that is stored within the customer database. If the return SMS message is sent using reverse billing SMS, the customer will be charged a designated fee on his or her standard phone bill. This eliminates the need for a separate billing transaction and enables the customer to have all music selections billed conveniently on his or her standard monthly phone bill. If the return billing SMS message and/or the debit processing is unsuccessful for a particular customer, the media files requested by that customer may be removed from the play queue 350 for the particular establishment.

Using the unique establishment identifier 375 accompanying the each request, the media server determines where to send the media information 370. The media server then sends the requested media information 380 to the establishment identified by the unique establishment identifier 375 in the establishment database 385. The requested media files are then outputted at each local establishment. The media information may be sent as streaming media, downloaded media files, or media identifiers to be locally retrieved and played by each local media player 395. In an exemplary embodiment, the media files are retrieved from a local database 325 coupled to the local media player and played locally. In another exemplary embodiment, the media files are retrieved from a remote database 325 coupled to a remote server and streamed to the local media player which then outputs the streaming media to the customers present at the local establishment 390.

In another exemplary embodiment, the media files are retrieved from a remote database 325 coupled to a remote server and downloads the media files to a media player which then locally plays and outputs the media files to the customers present at the local establishment 390. The process may operate continuously 397 as customers arrive and depart the local establishment. Alternately, if no requests are received within a predetermined time period, the process ends 399.

In summary, a system, method, and computer program product are provided which enables the customers of a localized physical establishment 150 to select specific musical media files to be publicly played within that establishment by entering data into a wireless portable computing device 205 on their person. Upon entering a media file selection into a portable computing device 205, a message is sent over a wireless link 85B to a media server 200 which maintains a playlist queue 230 for the establishment 150. In a exemplary embodiment the media server 205 is a remote server that maintains separate playlist queues 230 and separate media menus 237 for each of a plurality of localized physical establishments 150A,B,C. In an exemplary embodiment the wireless portable computing device 205 is a phone device and the message is sent to the media server 200 as a text message.

The various exemplary inventive embodiments described herein are intended to be merely illustrative of the principles underlying the inventive concept. It is therefore contemplated that various modifications of the disclosed embodiments will, without departing from the inventive spirit and scope, be apparent to persons of ordinary skill in the art. They are not intended to limit the inventive embodiments to any precise form described. In particular, it is contemplated that functional implementation of the various inventive embodiments described herein may be implemented equivalently in hardware, software, firmware, and/or other available functional components or building blocks. No specific limitation is intended to a particular arrangement or programmatic sequence. Other variations and inventive embodiments are possible in light of above teachings, and it is not intended that this Detailed Description limit the inventive scope, but rather by the Claims following herein.

What is claimed:

1. A distributed media selection system for physical establishments comprising:
a media server coupled to a network comprising;
a processor;
a computer readable storage medium coupled to the processor comprising;
a first database component having retrievably stored therein;
a plurality of physical establishment records, each physical establishment record being associated with a physical establishment and having a unique establishment identifier associated therewith;
a media playlist queue associated with each physical establishment record, each media playlist queue comprising a listing of unique media file identifiers, each of the unique media file identifiers being associated with a media file pending for play within the associated physical establishment;
a set of logical instructions which when executed by the processor cause the processor to;
receive over the network, s plurality of media requests comprising at least one media request initiated from each of a plurality of separate portable computing devices, each media request including a unique media identifier and a unique establishment identifier;
update, for each of two or more of the plurality of received media requests, the media playlist queue corresponding to the unique establishment identifier included in the media request, the update comprising adding a representation of at least one media identifier received in the media requests to the associated media playlist queue; and,
cause, for each of the two or more of the plurality of received media requests, at least one media file identified in the media requests to be publicly output at an associated physical establishment.

2. The system according to claim 1 further comprising a second database component coupled to the processor having retrievably stored therein a media menu corresponding to each unique establishment identifier, each media menu comprising a listing of media files and corresponding unique media identifiers available for selection and play at each corresponding physical establishment.

3. The system according to claim 1 wherein each of the plurality of separate portable computing devices are cellular telephones.

4. The system of claim 1 wherein each of the media requests comprises an SMS formatted text message.

5. The system according to claim 1 wherein each of the media requests further includes a unique customer identifier.

6. The system according to claim 5 further comprising a third database component coupled to the processor having retrievably stored therein a plurality of customer account records, each of the customer account records having a unique customer identifier associated therewith.

7. The system according to claim 6 further comprising logical instructions which when executed by the processor cause the processor to;
retrieve, for each of the two or more of plurality of received media requests, a customer account record from the third database component corresponding to the unique customer identifier included in the received media request; and,
charge a fee to each retrieved customer account record in dependence on whether a requested media file was publicly output at the physical establishment.

8. The system according to claim 5 wherein the unique customer identifier includes a phone number of the separate portable computing device from which the corresponding media request originated.

9. The system according to claim 5 wherein the unique customer identifier includes a text messaging address, a customer handle, or a customer name.

10. The system according to claim 1 wherein the network is one of; a cellular network, a cellular network coupled by a gateway to a public packet switched network and a local wireless network coupled by a gateway to a public packet switched network.

11. The system according to claim 1 wherein the output at each physical establishment is accomplished by a media player coupled to the network.

12. The system according to claim 11 wherein each media player receives the media files for output from the media server over the network.

13. The system according to claim 11 wherein each media player receives streaming media over the network of the media files for output from the media server.

14. The system according to claim 11 wherein each media player receives unique media identifiers from the media server and retrieves and plays, in accordance with the received unique media identifiers, corresponding media files from local datastores coupled to the media player.

15. The system according to claim 1 further comprising a physical menu disposed within each of the plurality of physical establishments, the physical menu including a printed listing of a plurality of media files and associated unique media identifiers available for selection and play within each physical establishment.

16. The system according to claim 15 wherein the physical menu further includes the unique establishment identifier associated with the physical establishment in which the physical menu is disposed.

17. The system according to claim 2 wherein a media menu for at least one of the physical establishment is downloadable from the media server to a separate portable computing device in dependence on the corresponding unique establishment identifier included in an electronic message from the separate portable computing device to the media server.

18. The system according to claim 6 further comprising logical instructions which when executed by the processor cause the processor to;
retrieve, for each of the two or more of the plurality of received media requests, a customer account record from the third database component in dependence on the unique customer identifier included in the received request; and,
store a usage record in the customer account record, the usage record including a representation of the requested media file and a representaion of the identified physical establishment included in the received request.

19. A computer implemented method for distributed media selection comprising:
receiving a plurality of media request over a network, the plurality of media requests comprising at least one of media request intitiated from each of a plurality of separate portable computing devices, each media request including a unique media identifier, a unique establishment identifier and a unique customer identifier;
updating, for each of two or more of the plurality of received media requests, a media playlist queue associated with the unique establishment identifier included in the media request, the updating comprising adding a representation of at least one media identifier received in the media requests to the corresponding media playlist queue; and,
causing for each of the two or more of the plurality of received media requests, at least one media file identified in the media request to be publicly output at an associated physical establishment.

20. The computer implemented method according to claim 19 further comprising charging a fee to at least one customer associated with the plurality of received media requests.

21. The computer implemented method according to claim 19 further comprising maintaining for at least one of the associated physical establishments, a separate playlist queue of media files pending to be locally output.

22. The computer implemented method according to claim 19 further comprising maintaining for at least one of the associated physical establishments, a separate listing of media files currently available for selection therefrom.

23. The computer implemented method according to claim 19 wherein each of the plurality of separate portable computing devices are portable telephone devices.

24. The computer implemented method according to claim 19 wherein at least a portion of the media requests is conveyed in a text messaging format.

25. A computer readable storage medium comprising instructions which when executed by a processor cause the processor to;
receive a plurality of media request over a network, comprising at least one media request initiated from each of a plurality of separate portable computing devices, each media request including a unique media identifier, a unique establishment identifier and a unique customer identifier;
update, for each of two or more of the plurality of received media requests, a media playlist queue associated with the unique establishment identifier included in the media request, the update comprising adding a representation of at least one received media identifier included in the media request to the media playlist queue; and,
cause, for each of the two or more of the plurality of received media requests, at least one of the media files identified in the media requests to be publicly output at an associated physical establishment.

26. The computer readable storage medium according to claim 25 further comprising instructions which when executed by a processor cause the processor to charge a fee to a at least one customer associated with the plurality of received media requests.
